(19) United States
(12) Patent Application Publication
(10) Pub. No.: US 2007/0068349 A1
(43) Pub. Date: Mar. 29, 2007

(54) Hexagonal wrench

(76) Inventor: Wen-Chen Min, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/524,729

(22) Filed: Sep. 21, 2006

(30) Foreign Application Priority Data
Sep. 29, 2005 (TW) 094216838

(51) Int. Cl. B25B 15/00; B25B 13/48; B25B 23/00

(52) U.S. Cl. 81/436

(57) ABSTRACT

A hexagonal wrench includes a slot adapted to be defined in at least one of the six side faces of the head to receive therein a ball and spring combination so that the ball in the ball and spring combination and urged by the spring of the ball and spring combination is able to automatically compensate a void between the hexagonal wrench and a hexagonal hole.

### BACKGROUND OF THE INVENTION

1. Field of the Invention

The present invention relates to a hexagonal wrench, and more particularly to a hexagonal wrench having a head formed on a distal end thereof and a ball and spring combination received in at least one slot defined in one of hexagonal sides of the head such that the ball protruding out of the at least one slot is able to abut an inner side face defining a hexagonal hole.

2. Description of the Prior Art

The current hexagonal wrench is to be fitted into a hexagonal hole to allow the user to tighten/loosen a workpiece having the hexagonal hole. After a long period of tightening/loosening the workpiece, the hexagonal hole is deformed, either enlarged or damaged. Due to reckless use of the hexagonal wrench, the hexagonal hole is often enlarged, which results in that the operator may not be able to use the wrench to fit into the hexagonal hole. Also, slipping out of the hexagonal hole of the hexagonal wrench often causes damage to the periphery of the hexagonal hole. Again, the damage to the periphery of the hexagonal hole hinders smooth operation of the hexagonal wrench.

In order to prevent damage to the periphery of the hexagonal hole, an improved hexagonal wrench is introduced to the market and has a radially defined slit in a side face of a distal end thereof and a threaded element threadingly extending from one of the six side faces of the hexagonal wrench to allow the distal end of the threaded element to abut one inner side face of the slit. Therefore, if the hexagonal hole is enlarged due to excessive use of the hexagonal wrench, the operator may screw the threaded element into the slit to enlarge the diameter of the distal end of the hexagonal wrench. As a result, the hexagonal wrench is able to be perfectly fitted into the hexagonal hole.

Another improved hexagonal wrench is provided with an annular neck defined close to the distal end of the hexagonal wrench so as to allow the operator to obliquely extend the hexagonal wrench into the hexagonal hole.

The first improved hexagonal wrench requires the operator to adjust the position of the threaded element before application of the hexagonal wrench to the hexagonal hole. The diameter of the distal end of this conventional hexagonal wrench needs to be adjusted again and again until the hexagonal wrench is perfectly fitted into the hexagonal hole, which is too troublesome.

The second improved hexagonal wrench may not be able to cope with the deformation of the hexagonal hole because there would be no interference fit between the hexagonal wrench and the hexagonal hole.

To overcome the shortcomings, the present invention tends to provide an improved hexagonal wrench to mitigate the aforementioned problems.

### SUMMARY OF THE INVENTION

The primary objective of the present invention is to provide an improved hexagonal wrench to allow the hexagonal wrench to be perfectly fitted in the hexagonal hole even after the hexagonal hole is deformed.

In order to accomplish the objective, the hexagonal wrench of the present invention has a head formed at a distal end thereof and having six independent yet interconnecting side faces, an annular neck defined close to the head and a slot defined in at least one of the six side faces to receive therein a ball and spring combination. The ball is securely received in the slot and urged by the spring which is sandwiched between a bottom face defining the slot and the ball. Therefore, after the head is extended into a deformed hexagonal hole, movement of the ball due to abutment of a side wall defining the hexagonal hole or a recovery force from the spring will automatically compensate a void between the hexagonal wrench and the hexagonal hole.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the hexagonal wrench of the present invention;

FIG. 2 is a cross sectional end view showing how the ball and spring combination compensates the void between the hexagonal wrench and the hexagonal hole;

FIG. 3 is a schematic side plan view showing when the hexagonal wrench of the present invention is extended into the hexagonal hole, the ball is forced by a side face of the hexagonal hole to move deeper into the slot of the hexagonal wrench; and

FIG. 4 is an operational perspective view showing the application of the hexagonal wrench of the present invention.

### DETAILED DESCRIPTION OF THE PREFERRED EMBODIMENT

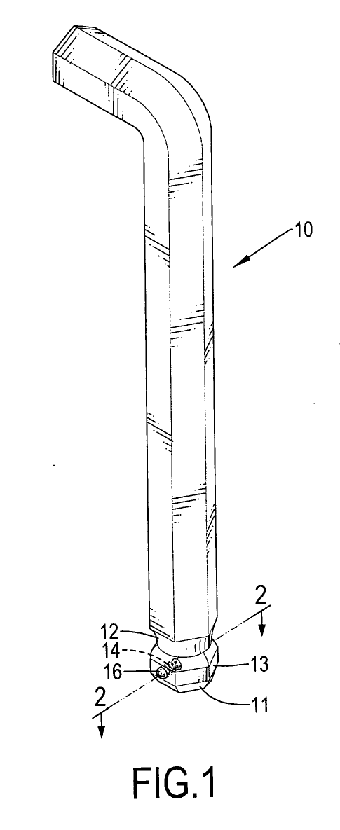

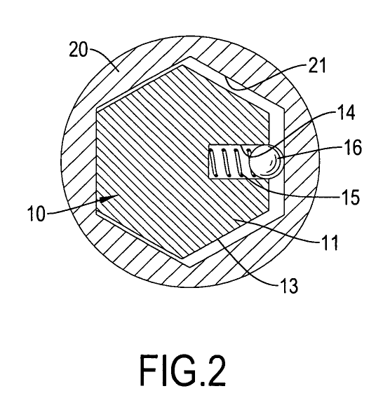

With reference to FIGS. 1 and 2, it is noted that the hexagonal wrench (10) in accordance with the present invention includes a first section having a first length and a second section integrally formed with the first section and having a second length longer than that of the first section.

The second section has a free distal end provided with a head (11) and an annular neck (12) defined in an outer periphery of the hexagonal wrench (10) close to the head (11). The head (11) has six independent yet interconnecting side faces (13). A slot (14) is defined in at least one (only one is shown in this embodiment) of the six side faces (13) to receive therein a ball and spring combination. That is, a spring (15) and a ball (16) are received inside the slot (14). A diameter of an opening (not numbered) of the slot (14) is smaller than that of the ball (16). A diameter of the ball (16) is smaller than that of the diameter of the slot (14) such that the ball (16) is able to freely move inside the slot (14). Also, the ball (16) is able to slightly protrude out of the slot (14) due to an urging force from the spring (15).

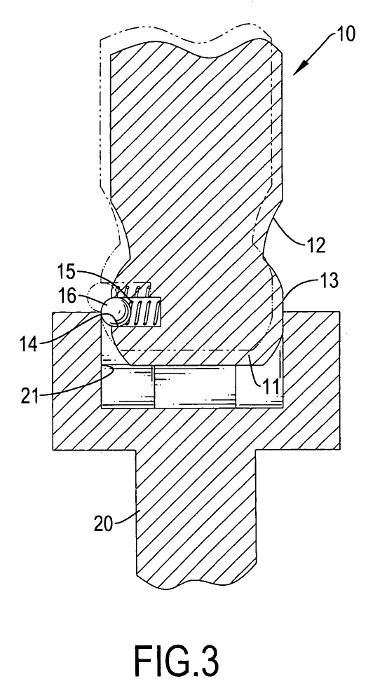

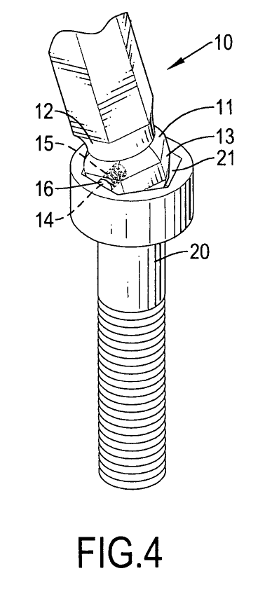

With reference to FIGS. 3 and 4, it is noted that due to the provision of the ball and spring combination inside the slot (14), when the hexagonal wrench (10) of the present invention is extended into a hexagonal hole (21) in an object (20), engagement between a side face defining the hexagonal hole (21) and the ball (1 6) forces the ball (1 6) to move into the slot (14). Due to the urging force from the spring (15), the ball (16) will maintain protruding out of the opening of the slot (14) to compensate a void between the hexagonal wrench (10) and the hexagonal hole (21) so as to facilitate a tight engagement between the remaining side faces (13) with side faces defining the hexagonal hole (21).

Even when the hexagonal wrench (10) is obliquely extended into the hexagonal hole (21), as shown in FIG. 4, the movement of the ball (16) ensures that the engagement between the remaining side faces (13) with side faces defining the hexagonal hole (21) is tightly fitted to one another.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hexagonal wrench having a first section with a first length and a second section integrally formed with the first section and having a second length longer than that of the first length, the second section having a head formed at a distal end thereof, an annular neck defined in an outer periphery close to the head and six independent yet interconnecting side faces, wherein the improvement comprises:
a slot is adapted to be defined in at least one of the six side faces to receive therein a ball and spring combination so that the ball in the ball and spring combination and urged by the spring of the ball and spring combination is able to automatically compensate a void between the hexagonal wrench and a hexagonal hole.

2. The hexagonal wrench as claimed in claim 1, wherein the slot has an opening with a first diameter and the ball has a second diameter which is larger than that of the first diameter such that the ball is kept inside the slot with a portion of the ball extending out of the slot.
